(19) United States
(12) Patent Application Publication
(10) Pub. No.: US 2026/0140244 A1
(43) Pub. Date: May 21, 2026

(54) SONAR TARGET ENHANCEMENT

(71) Applicant: William Fulton Bates, IV, Milton, GA (US)

(72) Inventor: William Fulton Bates, IV, Milton, GA (US)

(73) Assignee: Johnson Outdoors Inc., Racine, WI (US)

(21) Appl. No.: 19/392,968

(22) Filed: Nov. 18, 2025

Related U.S. Application Data
(60) Provisional application No. 63/722,778, filed on Nov. 20, 2024.

(51) Int. Cl. G01S 7/62; G01S 15/96

(52) U.S. Cl. CPC G01S 7/6218; G01S 15/96

(57) ABSTRACT

A sonar target enhancement system and method are provided for consumer fish finder live sonar image processing. The system and method identify and enhance the visualization of specific targets, such as fish and lures, detected by such live sonar imaging systems. A sonar image enhancement pipeline utilizes a target enhancement kernel sized in accordance with the subject targets to provide enhancement thereof without also enhancing other sonar return data. The output of the enhancement pipeline is combined with the sonar data from the normal image filtering pipeline to produce a sonar image for display on the consumer fish finder that greatly increases the visibility of the targets without affecting the non-target sonar returns for, e.g., the bottom and structure in the water column.

### CROSS-REFERENCE TO RELATED PATENT APPLICATIONS

This patent application claims the benefit of U.S. Provisional Patent Application No. 63/722,778, filed Nov. 20, 2024, the entire teachings and disclosure of which are incorporated herein by reference thereto.

### FIELD OF THE INVENTION

This invention generally relates to consumer fish finder live sonar image processing, and more particularly to fish finder live sonar image processing to identify and enhance visualization of specific targets such as fish and lures detected thereby.

### BACKGROUND OF THE INVENTION

Advances in consumer fish finder sonar imaging systems, such as those described in U.S. Pat. No. 11,914,066, entitled MULTIPLEXED PHASED ARRAY MULTIBEAM SONAR, to Carmona-Valdes et al., issued Feb. 27, 2024, the teachings and disclosure of which are hereby incorporated in their entireties for all purposes by reference thereto, have provided modern anglers with the ability to observe fish and structures underwater in real-time. Indeed, systems such as the MEGA Live Imaging® system available from the assignee of the instant application even allow the angler to watch fish on-screen as they move in to bite an angler's lure in multiple different modes, e.g., down mode, forward mode, and landscape mode.

With the enhancement of the fishing experience enabled by such real-time imagery, live action sonar systems have become invaluable for many anglers and have now been deployed in a myriad of fishing environments. However, because fishing environments have many different types of structure, deadfall, weed growth, and entrained bubbles and algae in the water column, besides anglers' preferences for a range of aquatic life from bait fish to trophy fish and use of different types of lures, jigs, and baits, there is increased pressure on such systems to provide imagery that clearly distinguishes the desired targets, e.g., fish or lures, on the sonar display from other returns displayed thereon.

Depending on the size and composition of the targets of interest and the proximity of structure and quality of the surrounding aquatic environment in which the target is swimming, the desired target's acoustic reflectivity may too low to be noticed above the sonar noise floor. Even when the target's reflection is above the noise floor, it may be insignificantly so compared to a harder or larger target like a bridge column around which it may be swimming or by which it may have been cast.

While there are many known image data processing techniques that can be employed to blur, sharpen, emboss, edge detect, etc., an image, their application to the above-described live sonar fish finder issues of distinguishing and enhancing a swimming target from an adjacent structure or while in a less than quiet aquatic environment has been disappointing.

What is needed, therefore, is a live sonar fish finder system and method that accentuates and distinguishes a moving target, e.g., a jig or fish target, while not also accentuating returns of other structure or allowing such accentuating to overpower a larger target return. Embodiments of the present invention provide such a system and method. These and other advantages of the invention, as well as additional inventive features, will be apparent from the description of the invention provided herein.

### BRIEF SUMMARY OF THE INVENTION

In view of the above, embodiments of the present invention provide a new and improved system and method for identifying and enhancing certain targets on a fish finder display. More specifically, embodiments of the present invention provide a new and improved system and method for identifying and enhancing certain targets on a fish finder display by using conservative template matching to the sonar echogram. Still more specifically, embodiments of the present invention provide a new and improved system and method for identifying and enhancing fishing lures and fish on a fish finder display by using conservative template matching on specific regions of the sonar echogram. Further, in certain embodiments and not to enhance random noise, the summation of weights of the template has value less than 0. This ensures any given dot product of the template matrix and a randomly sampled portion of the echogram will have an expected return value of less than 0.

In one embodiment, the system and method create an additional target layer for identification and enhancement that is then blended into the normal sonar image. In certain embodiments, prefiltering is performed before template convolution so that noise is not enhanced, and in some embodiments output exponential moving averaging (EMA) is used to prevent objects that excite the kernel from flickering harshly on the fish finder display. A blending constant appropriately matched to the kernel/template used in a particular embodiment is used in certain embodiments to multiply the template filtering output.

In certain embodiments, different kernels are selected for targets at different distances from the sonar transducer based on lateral resolution. Larger distance resolution embodiments preferably utilize non-square kernels to reject more horizontal structures such as fallen logs in the aquatic environment. Regardless of the particular kernel utilized, some embodiments apply deblurring methods used in the normal image filter pipeline to deblur the EMA output in the enhancement pipeline (or the target identification layer as used interchangeably herein).

In an embodiment, the system and method use template convolution on sonar data to identify likely targets of interest and cause the display to adjust the appearance of the identified areas. In one embodiment, the appearance of the identified areas is changed to a different color palette than the rest of the return, e.g., color the bait.

In various embodiments, the system and method of the present invention performs template convolution directly on an echogram by leveraging local rectangularity. In such an embodiment, the template convolution is not performed on the cartesian grid. In an embodiment, the raw sonar data is preprocessed using at least one of a gaussian blur, exponential moving average, non-gaussian blur (e.g., box blur), or any combination of the filters.

In certain embodiments, the system and method utilize different templates in different regions of the echogram based on computational analysis of the raw sonar data. In some embodiments the different templates are used based on non-sonar data, e.g., GPS data.

In an embodiment, the image is enhanced using the base echogram technique. In another embodiment, the image is enhanced using the adjustable addition technique. In certain embodiments, the template convolution is a 3-dimensional operation utilizing previous pings as the third dimension. In various embodiments, the template convolution happens on the polar array and the kernel used is modified as a function of the theta, i.e., rotating the kernel. In certain embodiments, the sonar data is a beamformed matrix.

In one embodiment, a method of accentuating at least one target ensonified by a sonar system within a fishing environment, without accentuating structures also ensonified by the sonar system, for presentation on a fish finder display, includes the steps of constructing a sonar echogram in polar coordinates from sonar echo returns from the water column ensonified by the sonar system, convolving a predetermined template matrix on specific regions of the sonar echogram to form a target layer having an enhanced target contained therein, blending the target layer with the sonar echogram to form a polar output sonar image, converting the polar output sonar image to cartesian coordinates to form an enhanced target sonar image, and displaying the enhanced target sonar image on the fish finder display.

In an embodiment, the step of convolving the predetermined template matrix on specific regions of the sonar echogram includes the step of convolving the predetermined template matrix having a summation of weights that is less than zero to prevent random noise in the sonar echogram from being enhanced in the target layer.

In an embodiment, the step of convolving the predetermined template matrix having the summation of weights that is less than zero to prevent the random noise in the sonar echogram from being enhanced in the target layer includes the step of ensuring that any given dot product of the template matrix and a randomly sampled portion of the sonar echogram will have an expected return value of less than zero.

In an embodiment, the method further includes the step of preprocessing the sonar echogram prior to the step of convolving.

In one embodiment, the step of preprocessing the sonar echogram includes the steps of applying at least one of a Gaussian blur, exponential moving average (EMA), non-Gaussian blur to the sonar echogram.

In an embodiment, the method further includes the step of preprocessing the sonar echogram prior to the step of convolving to prevent objects that excite the template matrix from flickering harshly on the fish finder display during the step of displaying the enhanced target sonar image on the fish finder display.

In an embodiment, the step of blending the target layer with the sonar echogram to form the polar output sonar image includes the step of multiplying the target layer with a blending constant appropriately matched to the template matrix prior to blending with the sonar echogram.

In an embodiment, the step of convolving the predetermined template matrix on specific regions of the sonar echogram includes the step of selecting from among different template matrices based on a distance of the target from a sonar transducer of the sonar system based on lateral resolution.

In an embodiment, the step of selecting from among different template matrices based on a distance of the target from a sonar transducer of the sonar system based on lateral resolution includes the step of selecting non-square template matrices beyond a predetermined distance to prevent enhancement of horizontal structures in the water column.

In an embodiment, the method further includes the step of performing exponential moving averaging to the target layer prior to the step of blending.

In an embodiment, the step of constructing the sonar echogram includes the step of constructing the sonar echogram represented by an approximately 256×752 matrix of 8-bit amplitude.

In an embodiment, the step of blending the target layer with the sonar echogram to form the polar output sonar image includes the step of blending the target layer with the sonar echogram to form the polar output sonar image represented by a 256×752 matrix of 8-bit amplitude. Preferably, the enhanced target contained therein has an amplitude larger than in the target in the sonar echogram, and other areas of the polar output sonar image are of the same amplitude as in the sonar echogram.

In an embodiment, the method also includes the step of preprocessing the sonar echogram prior to the step of convolving with an exponential moving average (EMA) filter by updating an amplitude of each element in the sonar echogram array to be equal to alpha*current_value+(1−alpha)*old_value, where alpha is a number between 0 and 1 and old_value is a corresponding EMA output array element from a previous iteration. Preferably, alpha is selected to be one of between 0.25 and 0.75, between 0.5 and 0.7, or to be 0.55.

In an embodiment, the step of convolving the predetermined template matrix on specific regions of the sonar echogram includes the step of convolving the sonar echogram data with a small template matrix that is of similar shape as the target for which enhancement is desired.

In an embodiment, the step of convolving the sonar echogram data with a small template matrix that is of similar shape as the target for which enhancement is desired includes the step of selecting the template matrix to be between a 5×5 matrix to a 5×7 matrix.

In an embodiment, the step of selecting the template matrix includes the step of selecting the template matrix to be as follows:

| | | | | |
|---|---|---|---|---|
| 0 | −4 | −7 | −4 | 0 |
| 0 | 0 | 0 | 0 | 0 |
| 0 | 5 | 16 | 5 | 0 |
| 0 | 0 | 0 | 0 | 0 |
| 0 | −4 | −7 | −4 | 0 |

In an embodiment, the step of selecting the template matrix includes the step of selecting the template matrix to be as follows:

| | | | | | | |
|---|---|---|---|---|---|---|
| 0 | 0 | −4 | −7 | −4 | 0 | 0 |
| −2 | 0 | 0 | 0 | 0 | 0 | −2 |
| −1 | 0 | 7 | 20 | 7 | 0 | −1 |
| −2 | 0 | 0 | 0 | 0 | 0 | −2 |
| 0 | 0 | −4 | −7 | −4 | 0 | 0 |

In an embodiment, the step of selecting the template matrix includes the step of selecting the template matrix to be as follows:

| | | | | | | |
|---|---|---|---|---|---|---|
| 0 | 0 | −4 | −7 | −4 | 0 | 0 |
| −3 | 0 | 0 | 0 | 0 | 0 | 0 |
| −3 | 0 | 7 | 20 | 7 | 0 | 0 |
| −3 | 0 | 0 | 0 | 0 | 0 | 0 |
| 0 | 0 | −4 | −7 | −4 | 0 | 0 |

In an embodiment, the method further includes the step of applying regional masks to the sonar echogram to segregate the sonar echogram into three specific regions corresponding to the water column, structure areas, and bottom prior to the step of convolving. Preferably, the step of convolving the predetermined template matrix on specific regions of the sonar echogram includes the step of convolving the predetermined template matrix on the specific region corresponding to the water column, convolving a more conservative template matrix on the specific region corresponding to the structure areas, and not convolving on the specific region corresponding to the bottom.

In another embodiment, the method further includes the steps of applying regional masks to the sonar echogram to segregate the sonar echogram into multiple regions, and selecting a unique template matrix to be convolved with each of the multiple regions.

In an embodiment, the step of applying regional masks to the sonar echogram to segregate the sonar echogram into multiple regions includes the step of applying regional masks to the sonar echogram to segregate the sonar echogram into three specific regions corresponding to water column, structure areas, and bottom prior to the step of convolving.

In one embodiment, the step of convolving the predetermined template matrix on specific regions of the sonar echogram includes the step of convolving the predetermined template matrix on the specific region corresponding to the water column, convolving a more conservative template matrix on the specific region corresponding to the structure areas, and not convolving on the specific region corresponding to the bottom.

In another embodiment the step of convolving the predetermined template matrix on specific regions of the sonar echogram includes the step of selecting from among different template matrices based on a distance of the target from a sonar transducer of the sonar system based on lateral resolution.

In an embodiment, the step of selecting from among different template matrices based on the distance of the target from the sonar transducer of the sonar system based on lateral resolution includes the step of selecting non-square template matrices beyond a predetermined distance to prevent enhancement of horizontal structures in the water column.

In one embodiment, the step of blending the target layer with the sonar echogram to form the polar output sonar image includes the steps of masking the sonar echogram with the target layer as a mask to form a masked sonar echogram, low pass filtering the masked sonar echogram to obtain filtered normal data in which the step of low pass filtering has a lesser effect on data in the mask than areas not in the mask, and blending the target layer with the filtered normal data as the sonar echogram to form the polar output sonar image.

In another embodiment, the step of blending the target layer with the sonar echogram to form the polar output sonar image includes the steps of masking the sonar echogram with the target layer as a mask to form a masked sonar echogram, exponential moving average filtering the masked sonar echogram such that each element of the masked echogram is alpha_bypass*current_value+(1−alpha_bypass)*old_value, when the element is in the mask, or is alpha*current_value+(1−alpha)*old_value, otherwise, wherein 1≥alpha_bypass>alpha>0, and blending the target layer with the filtered normal data as the sonar echogram to form the polar output sonar image.

In an embodiment, the step of blending the target layer with the sonar echogram to form the polar output sonar image includes the steps of masking the sonar echogram with the target layer as a mask to form a masked sonar echogram, spatial low pass filtering the masked sonar echogram using at least one of a box or gaussian blur, convolving a first kernel chosen for the box or gaussian blur, K, across the masked sonar echogram on all points except the points in the mask, convolving a second kernel chosen for the box or gaussian blur, K_target, across the masked sonar echogram on all points in the mask, and blending the target layer with the filtered normal data as the sonar echogram to form the polar output sonar image.

In one embodiment, the step of blending the target layer with the sonar echogram to form the polar output sonar image includes the steps of: dilating the target layer to form a dilated mask that encloses a spatial margin around the enhanced target; masking the sonar echogram with the dilated mask to form a masked sonar echogram; performing at least one of the steps of (a) low pass filtering the masked sonar echogram to obtain filtered normal data in which the step of low pass filtering have a lesser effect on data in the mask than areas not in the mask, (b) exponential moving average filtering the masked sonar echogram such that each element of the masked echogram is alpha_bypass*current_value+(1−alpha_bypass)*old_value, when the element is in the mask, or is alpha*current_value+(1−alpha)*old_value, otherwise, wherein 1≥alpha_bypass>alpha>0, (c) spatial low pass filtering the masked sonar echogram using at least one of a box or gaussian blur, convolving a first kernel chosen for the box or gaussian blur, K, across the masked sonar echogram on all points except the points in the mask, convolving a second kernel chosen for the box or gaussian blur, K_target, across the masked sonar echogram on all points in the mask; and blending the target layer with the filtered normal data as the sonar echogram to form the polar output sonar image.

In another embodiment, a method of accentuating at least one target ensonified in a fishing environment by a sonar system, without accentuating structures in the fishing environment also ensonified by the sonar system, for presentation on a fish finder display, includes the steps of constructing a sonar echogram from sonar echo returns from the fishing environment ensonified by the sonar system, convolving a predetermined template matrix on specific regions of the sonar echogram to form a target layer having an enhanced target contained therein, blending the target layer with the sonar echogram to form an enhanced target sonar image, and displaying the enhanced target sonar image on the fish finder display.

Other aspects, objectives and advantages of the invention will become more apparent from the following detailed description when taken in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings incorporated in and forming a part of the specification illustrate several aspects of the present invention and, together with the description, serve to explain the principles of the invention. In the drawings:

FIG. 1 is a sonar image pipeline flow diagram illustrating a normal sonar image filter pipeline and an enhancement pipeline configured to enhance certain targets in accordance with an embodiment of the present invention;

FIG. 2 is an illustration of a raw sonar image layer input to the sonar image pipeline of FIG. 1;

FIG. 3 is an illustration of the prefiltered data of the raw sonar image layer input of FIG. 2 generated in the enhancement pipeline of FIG. 1;

FIG. 4 is an illustration of the sonar image data generated from the prefiltered data of FIG. 3 by the template convolution of the enhancement pipeline of FIG. 1;

FIG. 5 is an illustration of the final polar sonar output image blending the sonar image of the normal sonar image filter pipeline with the sonar image data post template convolution of FIG. 4 generated by the sonar image pipeline flow diagram of FIG. 1;

FIG. 6 is an illustration of the cartesian image generated from the final polar sonar output image of FIG. 5 to be displayed on the fish finder display;

FIG. 7 is an illustration of the cartesian image generated from the raw sonar image layer input of FIG. 2 with the enhancement pipeline of the sonar image pipeline flow diagram of FIG. 1 disabled to be displayed on the fish finder display;

FIG. 8 is an illustration of a cartesian image generated from a raw sonar image layer input with the enhancement pipeline of the sonar image pipeline flow diagram of FIG. 1 disabled to be displayed on the fish finder display;

FIG. 9 is an illustration of the cartesian image generated from a final blended polar image of the raw sonar image layer input, used to generate the cartesian image of FIG. 8, of the normal sonar image filter pipeline with the sonar image data generated by the enhancement pipeline of FIG. 1;

FIG. 10 is an illustration of another cartesian image generated from another raw sonar image layer input with the enhancement pipeline of the sonar image pipeline flow diagram of FIG. 1 disabled to be displayed on the fish finder display; and

FIG. 11 is an illustration of the cartesian image generated from a final blended polar image of the raw sonar image layer input, used to generate the cartesian image of FIG. 10, of the normal sonar image filter pipeline with the sonar image data generated by the enhancement pipeline of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, there are illustrated embodiments of the present invention and exemplary sonar image data at various stages in the target enhancement pipeline. However, those skilled in the art will recognize from the description herein that the invention is not so limited to the illustrated embodiments or particular sonar data illustrated therein, and therefore such drawings and the embodiments and images should be taken by way of example and not by way of limitation.

In order to enhance the detection and visualization of specific targets, such as lures and fish, in real-time 2-D sonar images, embodiments of the present invention provide a system and method for real time accentuating of certain sonar targets. However, because the aquatic environment typically includes deadfall, bottom structures, and elements in the water column as discussed above, such systems and methods must also ensure that these other structure and objects that are not fish or lures are not accentuated, which complicates what otherwise could be a straightforward application of linear image filtering using kernel convolution. A further complication limiting such process is the fact that the beamformed sonar return data is polar in nature while the two-dimensional image displayed to the angler on the fish finder utilizes a cartesian coordinate system on which such kernel convolution is typically applied.

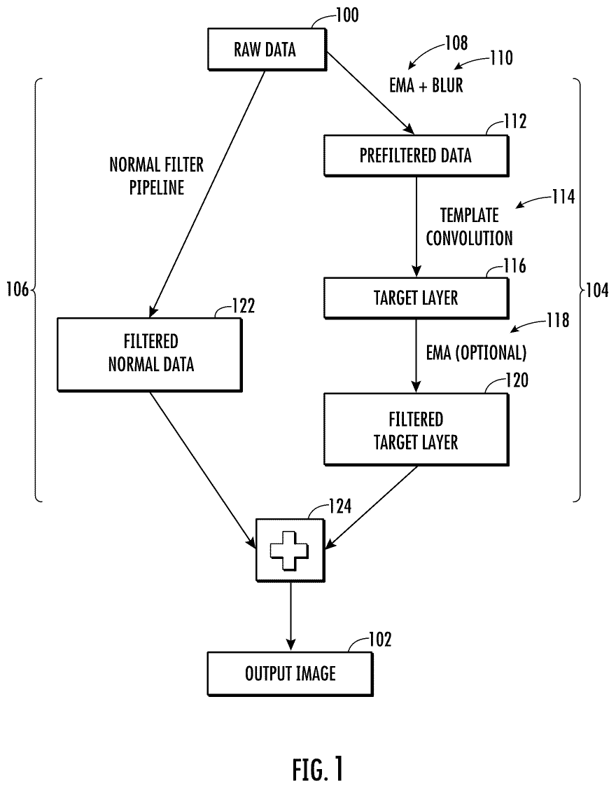

In the real-time sonar fish finding application of an embodiment of a system and method of the present invention, such as that shown in the sonar image pipeline flow diagram of FIG. 1, the input raw sonar data 100 is contained in an echogram represented by a 256×752 matrix of 8-bit amplitude data. However, both the size and amplitude may vary depending on the particulars of the underlying sonar system from which such raw sonar data 100 is generated. In such an exemplary echogram, however, the 256 rows equate to beams represented at various angles, and the 752 columns equate to the range quantization values represented at possible distances. As will be recognized by those skilled in the art, such a matrix utilizes polar data.

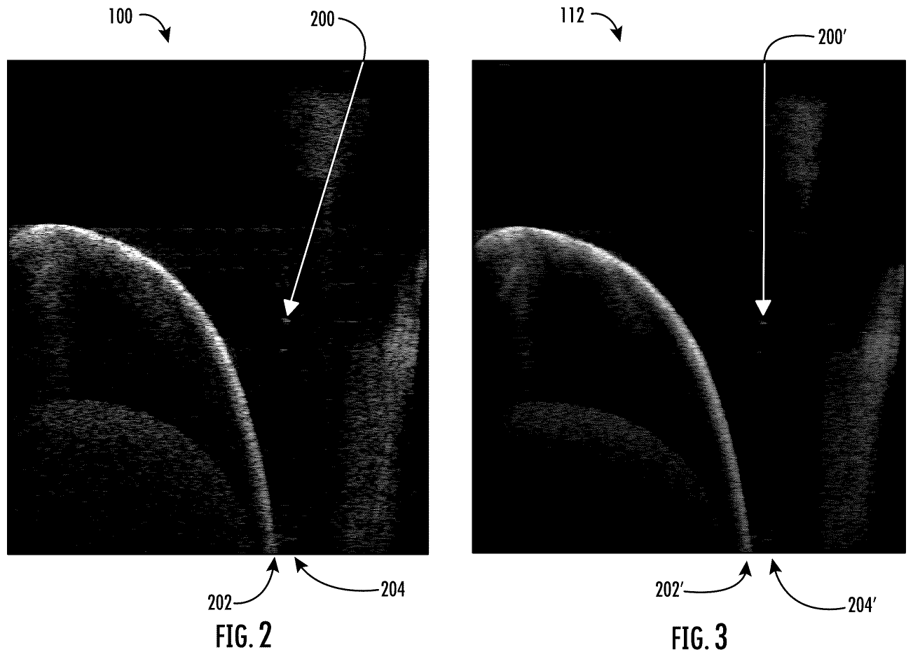

An example of such raw sonar image layer 100 input to the sonar image pipeline of FIG. 1 may be seen from the illustration of FIG. 2. As may be seen in this FIG. 2, there is a raw target return 200, a raw bottom return 202, and a raw structure return 204 in this sonar image layer 100.

When such input sonar data 100 is acted upon by embodiments of the system and method of the present invention, the output 102 provides an enhanced two-dimensional (2-D) image (see, e.g., the illustration of FIG. 5). This enhanced output 102 in the present embodiment is also an echogram represented by a 256×752 matrix of 8-bit amplitude data, wherein the 256 rows (beams) continue to represent various angles and the 752 columns (range quantization values) represent possible distances. However, in this enhanced output echogram 102 the desired targets 200′″, e.g., lures and fish, are generally represented with larger amplitudes than the input echogram, which non-targets, e.g. the bottom 202′″ and structure 204′″ are generally represented with the same amplitudes as the input echogram.

Specifically, as illustrated in FIG. 1, the input 100 echogram of raw sonar return data undergoes preprocessing in the enhancement pipeline 104. During this preprocessing, the system denoises the input echogram using well-known techniques for image and video processing.

First, the system utilizes an exponential moving average (EMA) filter 108 that takes advantage of the fact that two pings are correlated. For each element in the echogram array, the system updates its value to be equal to:

$$alpha * current\_value + ( 1 - alpha ) * old\_value \qquad ( 1 )$$

where alpha is a number between 0 and 1 and old_value is the corresponding EMA output array element from the previous iteration. As alpha approaches 1, the system uses more data from the current ping, whereas where alpha approaches 0 the system uses more data from previous pings.

Selection of alpha preferably recognizes that use of more data from the current ping makes the system susceptible to transient noise, whereas too little data from the current ping can cause the system to miss high frequency components of the signal. In certain embodiments, therefore, alpha is selected to be between 0 and 1, preferably between 0.25 and 0.75, and more preferably between 0.5 and 0.7. In one embodiment, alpha is 0.55.

Second, to further reduce noise, the system utilizes a novel application of the Gaussian blur 110 on the polar data of the echogram to achieve prefiltered data 112. FIG. 3 provides an illustration of a sonar image of such prefiltered data 112. As may be seen from the target 200′, ground 202′, and the structure 204′ returns, the images are smoothed compared to the raw images of FIG. 2.

While the array of sonar data is indeed rectangular, the physical meaning of such data is not. For example, take the echogram data points that are a distance of 1 quantization unit away from the transducer. When converted to cartesian coordinates, the distance between adjacent data points is close to 0. At further ranges, this distance can be up to multiple feet.

Typically, a two-dimensional convolution 114 and Gaussian blur 110 on this sort of data would distort its meaning. However, in embodiments of the present invention, the inventors have recognized that when a kernel to provide the desired target enhancement is properly constructed recognizing the size of the targets of interest here, the size of the kernel for the blur is small relative to the echogram array itself. Because of this extreme size disparity, the system of the present invention can apply such a blur despite the polar nature of the data by taking advantage of local rectangularity. In other words, the inventors have recognized that small subarrays of an echogram approach the shape of a rectangle, thus the convolution operation 114 can have a sensible physical meaning even if application to the full array of the echogram itself would not.

In order properly to enhance the desired targets without also enhancing other structures, etc., embodiments of the system of the present invention employ target identification in the form of template matching to select the proper small subarrays of the echogram. This method simply involves convolving 114 the prefiltered data 112 of the echogram data array with a small kernel that is of the rough shape as the targets for which enhancement is desired. For targets such as lures and fish, and while the rough shape may vary depending on species and type of lure in the echogram, the rough shape is selected to be generally 5×5 to 5×7 for a 256×752 echogram. Selection of such a small subarray as the rough shape of the desired target allows the exploitation of the local rectangularity to enable the system to convolve 114 the prefiltered data 112 of the echogram with the kernel as if it were cartesian data.

In one embodiment, the kernel used for target enhancement is a 5×5 matrix, the weights of which sum to −4, as follows:

| | | | | |
|---|---|---|---|---|
| 0 | −4 | −7 | −4 | 0 |
| 0 | 0 | 0 | 0 | 0 |
| 0 | 5 | 16 | 5 | 0 |
| 0 | 0 | 0 | 0 | 0 |
| 0 | −4 | −7 | −4 | 0 |

In another embodiment shown below, a relatively conservative 5×7 kernel whose sum of the weights is −6 may be used. Convolving this kernel over random noise would produce an expected value of 0 when clamped to the output range [0, 255] as discussed below.

| | | | | | | |
|---|---|---|---|---|---|---|
| 0 | 0 | −4 | −7 | −4 | 0 | 0 |
| −2 | 0 | 0 | 0 | 0 | 0 | −2 |
| −1 | 0 | 7 | 20 | 7 | 0 | −1 |
| −2 | 0 | 0 | 0 | 0 | 0 | −2 |
| 0 | 0 | −4 | −7 | −4 | 0 | 0 |

Note the width of the above kernel is longer than the height. This is to accommodate the greater spatial resolution in the time axis as opposed to the angle axis.

In a further embodiment, the 5×7 kernel shown below may be used to enhance targets that are moving closer to the transducer. One such target of particular interest in embodiments of the present invention is the lure.

| | | | | | | |
|---|---|---|---|---|---|---|
| 0 | 0 | −4 | −7 | −4 | 0 | 0 |
| −3 | 0 | 0 | 0 | 0 | 0 | 0 |
| −3 | 0 | 7 | 20 | 7 | 0 | 0 |
| −3 | 0 | 0 | 0 | 0 | 0 | 0 |
| 0 | 0 | −4 | −7 | −4 | 0 | 0 |

This kernel works particularly well for a lure moving closer to the transducer because the prefiltering (108, 110) discussed above can cause an amplitude trail to develop from lures moving closer to the transducer. The symmetric kernels penalize this trail, whereas the above kernel does not.

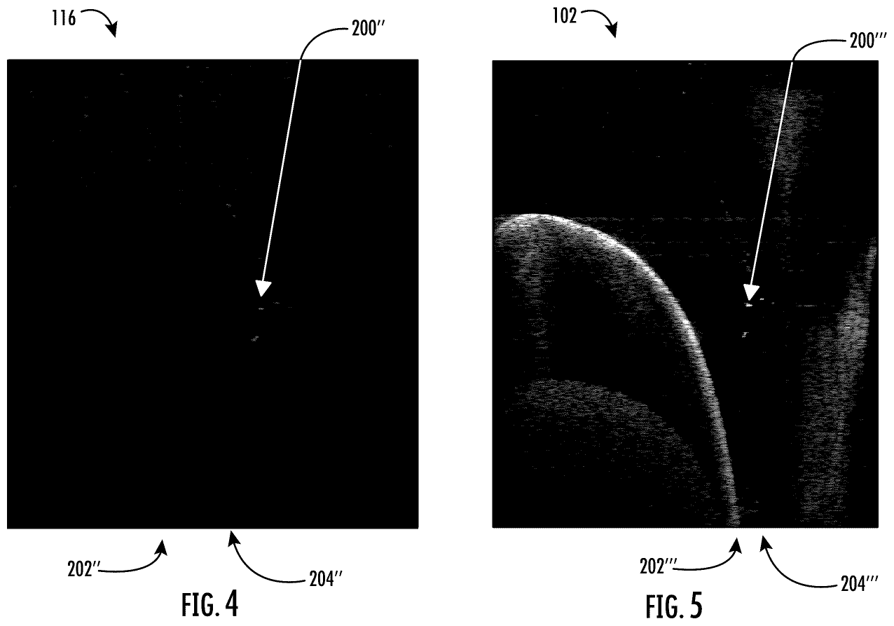

The result of such convolution 114 is an echogram target layer 116 in which targets 200″ (see FIG. 4) of interest are generally represented by large amplitude values and non-targets (e.g., the bottom 202″ and structure 204″) are generally represented by 0. In certain embodiments, the system clamps the output of all dot product operations that are part of the convolution 114 to [0, 255] in order to maintain data typing.

The balance that must be struck here, as opposed to general linear image filtering by kernel convolution, is that the system must use a template that correctly matches targets that are fish and lures, but also one that does not match non-targets. If a template convolution 114 matches a non-target, that is a false positive.

The opposite condition where a desired target, e.g., a fish or a lure, is not matched during convolution 114 is a false negative. There are several ways that false negatives can occur. One example is when noise disrupts the expected shape of a target in the water column. Another example is when the target, e.g., the lure or fish, is near a piece of structure like a tree. Ideally, the angler would want the system to accentuate those targets, but not at the risk of accentuating similar structure everywhere else.

In order to address and reduce such issues, certain embodiments employ regional masks. Such a regional mask is an array in the same 256×752 shape as the sonar echogram that is used to enable proper selection of a kernel to use for template matching or whether not to use template matching at all.

In one embodiment the regional masks effectively split the echogram into three regions, e.g., the water column, structure areas, and the bottom. With such a regional mask the system uses an aggressive template to convolve in the water column region because through testing it has been determined that there are less false positives in this region. The system may then use a very conservative template for the structure regions to avoid enhancing non-target structures, while still recognizing that there are targets in such region that might still be enhanced. However, to limit the recognized potential for such false positives, the system is more conservative with the template matching in these structure regions. Finally, the system does not employ template matching on the bottom region since there is little chance that targets could conceivably be there.

In certain embodiments, the system applies an exponential moving average (EMA) 118 to the output of the target layer 116 to achieve a filtered target layer 120 when a very precise kernel is used in the template matching step. This EMA is beneficial with the use of very precise kernels because slight variations in the background noise from one ping to the next can cause the kernel not to activate and thus can cause the appearance of flickering. Setting the output of the target layer 116, or the enhanced layer to be:

$$e ( theta , d ) = beta * e\_prev ( theta , d ) + ( 1 - beta ) * e ( theta , d ) \qquad ( 2 )$$

can alleviate this flickering. Known stabilization techniques are used in certain embodiments to ensure such averaging does not “blur” from frame to frame.

Having identified and enhanced the desired targets in the enhancement pipeline 104 or the target identification layer, the system then includes that enhanced target data of the filtered target layer 120 in the output 102 to the fish finder display. While provided in certain embodiments and as selectable by a user, in other embodiments the output 116 (or 120 if the optional EMA 118 is used) of the enhancement pipeline 104 or the target identification layer is not sent alone to the fish finder for display because that would not include other objects of interest to many anglers that are simply not defined as targets for enhancement, including bottom features and structure in the water column that provide context and useful information (see, e.g., FIG. 4). However, some anglers in certain environments may wish only to display such enhanced targets 200″, e.g., their jig and fish, and therefore such an option is provided in an embodiment.

In another embodiment, however, the information output 120 from the enhancement pipeline 104 or the target identification layer is combined with the normal pipeline information 122 from the normal sonar image pipeline 106 by adjustable addition 124, an exemplary image of which is illustrated in FIG. 5. As may be seen, the bottom returns 202′″ and structure returns 204′″ are of the same magnitude as in FIG. 2, while the target returns 200′″ are greatly enhanced.

In such an embodiment p(theta, d) signifies the echogram value at angle theta and distance d as calculated by the normal pipeline 106, and e(theta, d) signifies the value calculated through the enhancement pipeline 104 or the target identification layer. In this embodiment, then, the output value 102 for display on the fish finder is:

$$o ( theta , d ) = min ( 255 , p ( theta , d ) + alpha * e ( theta , d ) ) \qquad ( 3 )$$

In this embodiment the min function ensures that the sum does not go out of range of the data type. The alpha in this case is a constant chosen such that blending of the layers appears more natural. In one embodiment alpha is chosen to be 10, in a preferred embodiment to be 4, and in an even more preferred embodiment 12. The optimal alpha value heavily depends on the kernel being used, and in one embodiment alpha is determined empirically. A given kernel can have a large “leverage” if the positive weights and negative weights are both high in magnitude. This creates a very sharp output function when clamped from 0-255. For example, in a kernel with positive weights of 1000 and negative weights of −200 each summing up to −1200, most of the output matrix elements will be either 0 or 255. The alpha is then used to naturally smooth this out. Because the behavior with more typical kernels and real data is difficult to model theoretically, the value of alpha is determined through empirical testing to determine the optimal value.

In another embodiment, the information from the enhancement pipeline 104 or the target identification layer 116 is combined with the normal pipeline 106 information by base echogram gain. In such an embodiment a threshold is applied to the enhancement pipeline 104 or the target identification layer 116. For objects in parts of the echogram where the enhancement pipeline 104 or the target identification layer 116 is above the threshold, the gain is increased on the normal pipeline 106. The output 102 is not an additive output in this case, but a slightly modified version of the original echogram 100, thus preserving size and structure of objects.

In certain embodiments that utilize one or more low pass filters to remove temporal or spatial noise from the raw data 100 to obtain the filtered normal data 122 in the normal filtering pipeline 106, the target layer 116 is used as a mask in which the low pass filters have a lesser effect on areas in the mask than areas not in the mask.

In one such embodiment, the normal filtering pipeline 106 has an exponential moving average filter across pings which is configured to update each element of the echogram such that alpha_bypass*current_value+(1−alpha_bypass)*old_value, if the element is in target mask, or alpha*current_value+(1−alpha)*old_value, otherwise. In such an embodiment, 1≥alpha_bypass>alpha>0. This ensures that temporal smoothing has less effect on areas predicted to be targets by the enhancement pipeline 104.

In another embodiment in which the normal filtering pipeline 106 has a spatial low pass filter such as a box or gaussian blur, the kernel chosen for the blur, K, is convolved across the echogram on all points except the points in the target mask. The points in the target mask will be convolved with kernel K_target which has the property that the normalized dot product of K_target with local pixels tends more toward the center pixel value than the dot product with K.

In another embodiment, the target layer 116 is dilated to form a mask (dilated mask) that encloses a spatial margin around detections. The dilation radius (in pixels) may be static or adaptively selected from target size, confidence, or motion estimates. This mask is then used to bypass or reduce temporal or spatial low pass filtering as above.

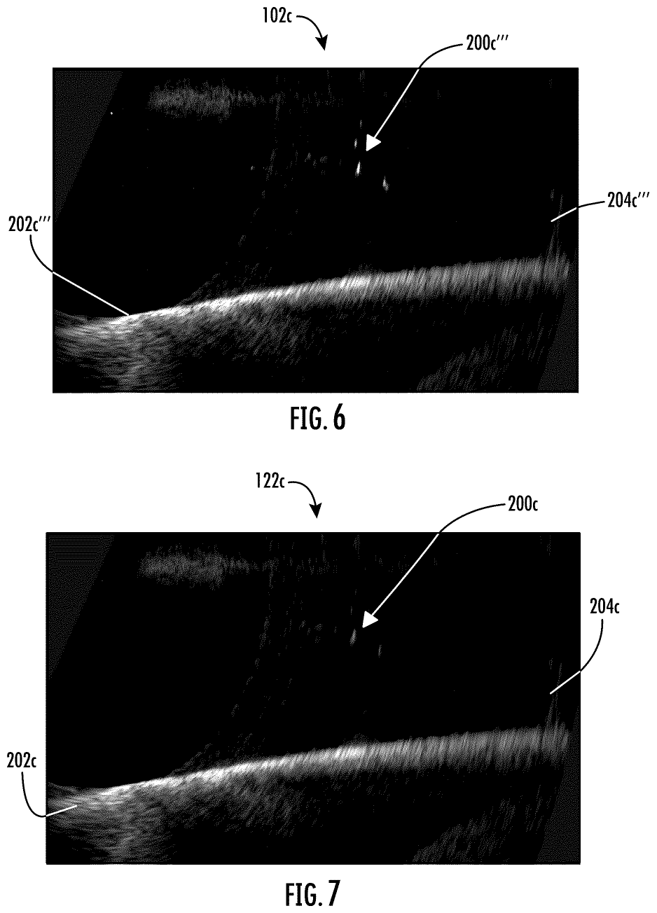

Regardless of the combination technique used in different embodiments, this enhanced polar sonar information in the output image 102 is converted to an enhanced sonar display image 102_{C} in Cartesian coordinates for actual display on the fish finder, such as that illustrated in FIG. 6. As may be seen from a comparison of this enhanced sonar display image 102_{C} of FIG. 6 to a normal sonar display image 122_{C} shown in FIG. 7 generated with the enhancement pipeline 104 disabled, the targets 200_{C}′″ of FIG. 6 are much more visible than the targets 200_{C} of FIG. 7, while there is no difference in the bottom 202_{C}′″ vs. 202_{C} or the structure 204_{C}′″ vs. 204_{C} returns of these two images.

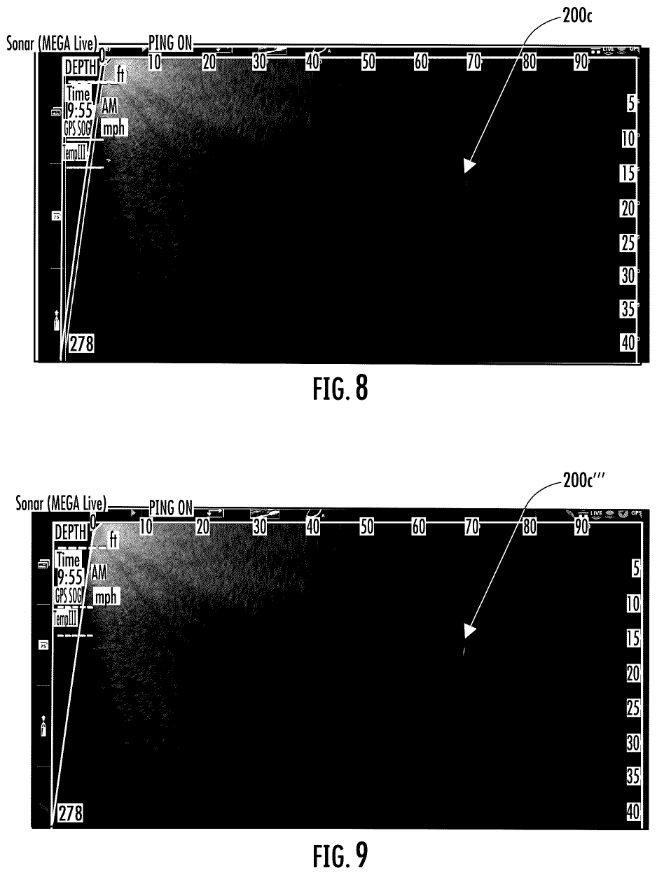

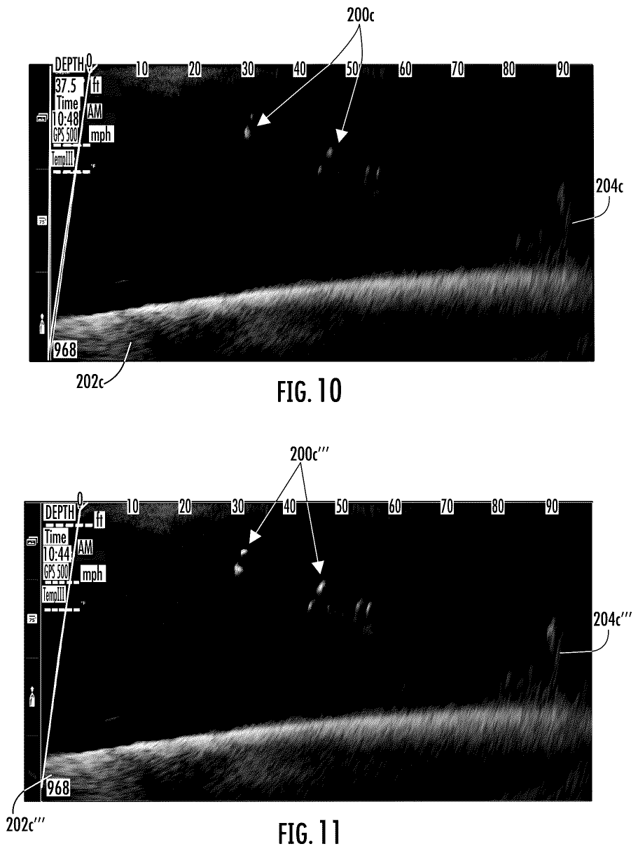

Similar differences, i.e., enhancement of targets without enhancement of non-targets, may be seen from a comparison of two different sonar imaging examples, to wit, a deep water sonar imaging example with no bottom or structure shown in FIG. 8 (non-enhanced) vs. FIG. 9 (enhanced), and a shallow water example with a hard bottom and structure shown in FIG. 10 (non-enhanced) vs. FIG. 11 (enhanced).

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein.

For example, while the sonar data used in the above discussion was generated by the consumer live sonar imaging system described in the incorporated by reference U.S. Pat. No. 11,914,066, entitled MULTIPLEXED PHASED ARRAY MULTIBEAM SONAR, other sonar systems using different sonar technology may be used to generate the sonar return data processed by embodiments of the present invention to enhance targets therein. Further, while the exemplary embodiment discussed above utilized a 2-dimensional kernel, other embodiments may utilize a 3-dimensional kernel utilizing previous pings as the third dimension to enhance targets moving toward/away from the boat or falling downward or rising upward.

Accordingly, this invention includes all modifications and equivalents of the subject matter recited in the claims appended hereto as permitted by applicable law regardless of the source of the raw sonar image data input to the pipelines of the present invention. Moreover, any combination of the above-described elements in all possible variations thereof is encompassed by the invention unless otherwise indicated herein or otherwise clearly contradicted by context.

What is claimed is:

1. A method of accentuating at least one target ensonified in a fishing environment by a sonar system, without accentuating structures in the fishing environment also ensonified by the sonar system, for presentation on a fish finder display, comprising the steps of:
constructing a sonar echogram in polar coordinates from sonar echo returns from the fishing environment ensonified by the sonar system;
convolving a predetermined template matrix on specific regions of the sonar echogram to form a target layer having an enhanced target contained therein;
blending the target layer with the sonar echogram to form a polar output sonar image;
converting the polar output sonar image to cartesian coordinates to form an enhanced target sonar image; and
displaying the enhanced target sonar image on the fish finder display.

2. The method of claim 1, wherein the step of convolving the predetermined template matrix on specific regions of the sonar echogram includes the step of convolving the predetermined template matrix having a summation of weights that is less than zero to prevent random noise in the sonar echogram from being enhanced in the target layer.

3. The method of claim 2, wherein the step of convolving the predetermined template matrix having the summation of weights that is less than zero to prevent the random noise in the sonar echogram from being enhanced in the target layer comprises the step of ensuring that any given dot product of the template matrix and a randomly sampled portion of the sonar echogram will have an expected return value of less than zero.

4. The method of claim 1, further comprising the step of preprocessing the sonar echogram prior to the step of convolving.

5. The method of claim 4, wherein the step of preprocessing the sonar echogram comprises the steps of applying at least one of a Gaussian blur, exponential moving average (EMA), non-Gaussian blur to the sonar echogram.

6. The method of claim 1, further comprising the step of preprocessing the sonar echogram prior to the step of convolving to prevent objects that excite the template matrix from flickering harshly on the fish finder display during the step of displaying the enhanced target sonar image on the fish finder display.

7. The method of claim 1, wherein the step of blending the target layer with the sonar echogram to form the polar output sonar image comprises the step of multiplying the target layer with a blending constant appropriately matched to the template matrix prior to blending with the sonar echogram.

8. The method of claim 1, wherein the step of convolving the predetermined template matrix on specific regions of the sonar echogram comprises the step of selecting from among different template matrices based on a distance of the target from a sonar transducer of the sonar system based on lateral resolution.

9. The method of claim 8, wherein the step of selecting from among different template matrices based on a distance of the target from a sonar transducer of the sonar system based on lateral resolution comprises the step of selecting non-square template matrices beyond a predetermined distance to prevent enhancement of horizontal structures in the water column.

10. The method of claim 1, further comprising the step of performing exponential moving averaging to the target layer prior to the step of blending.

11. The method of claim 1, wherein the step of constructing the sonar echogram comprises the step of constructing the sonar echogram represented by approximately a 256×752 matrix of 8-bit amplitude.

12. The method of claim 11, wherein the step of blending the target layer with the sonar echogram to form the polar output sonar image comprises the step of blending the target layer with the sonar echogram to form the polar output sonar image represented by approximately a 256×752 matrix of 8-bit amplitude, wherein the enhanced target contained therein has an amplitude larger than in the target in the sonar echogram, and wherein other areas of the polar output sonar image are of the same amplitude as in the sonar echogram.

13. The method of claim 1, further comprising the step of preprocessing the sonar echogram prior to the step of convolving with an exponential moving average (EMA) filter by updating an amplitude of each element in the sonar echogram array to be equal to alpha*current_value+(1−alpha)*old_value, where alpha is a number between 0 and 1 and old_value is a corresponding EMA output array element from a previous iteration.

14. The method of claim 13, wherein alpha is selected to be one of between 0.25 and 0.75, between 0.5 and 0.7, or to be 0.55.

15. The method of claim 1, wherein the step of convolving the predetermined template matrix on specific regions of the sonar echogram comprises the step of convolving the sonar echogram data with a small template matrix that is of similar shape as the target for which enhancement is desired.

16. The method of claim 15, wherein the step of convolving the sonar echogram data with a small template matrix that is of similar shape as the target for which enhancement is desired comprises the step of selecting the template matrix to be from a 5×5 matrix to a 5×7 matrix.

17. The method of claim 1, further comprising the steps of applying regional masks to the sonar echogram to segregate the sonar echogram into multiple regions, and selecting a unique template matrix to be convolved with each of the multiple regions.

18. The method of claim 17, wherein the step of applying regional masks to the sonar echogram to segregate the sonar echogram into multiple regions comprises the step of applying regional masks to the sonar echogram to segregate the sonar echogram into three specific regions corresponding to water column, structure areas, and bottom prior to the step of convolving.

19. The method of claim 18, wherein the step of convolving the predetermined template matrix on specific regions of the sonar echogram comprises the step of convolving the predetermined template matrix on the specific region corresponding to the water column, convolving a more conservative template matrix on the specific region corresponding to the structure areas, and not convolving on the specific region corresponding to the bottom.

20. The method of claim 1, wherein the step of blending the target layer with the sonar echogram to form the polar output sonar image comprises the steps of masking the sonar echogram with the target layer as a mask to form a masked sonar echogram, low pass filtering the masked sonar echogram to obtain filtered normal data in which the step of low pass filtering has a lesser effect on data in the mask than areas not in the mask, and blending the target layer with the filtered normal data as the sonar echogram to form the polar output sonar image.

21. The method of claim 1, wherein the step of blending the target layer with the sonar echogram to form the polar output sonar image comprises the steps of masking the sonar echogram with the target layer as a mask to form a masked sonar echogram, exponential moving average filtering the masked sonar echogram such that each element of the masked echogram is alpha_bypass*current_value+(1−alpha_bypass)*old_value, when the element is in the mask, or is alpha*current_value+(1−alpha)*old_value, otherwise, wherein 1≥alpha_bypass>alpha>0, and blending the target layer with the filtered normal data as the sonar echogram to form the polar output sonar image.

22. The method of claim 1, wherein the step of blending the target layer with the sonar echogram to form the polar output sonar image comprises the steps of masking the sonar echogram with the target layer as a mask to form a masked sonar echogram, spatial low pass filtering the masked sonar echogram using at least one of a box or gaussian blur, convolving a first kernel chosen for the box or gaussian blur, K, across the masked sonar echogram on all points except the points in the mask, convolving a second kernel chosen for the box or gaussian blur, K_target, across the masked sonar echogram on all points in the mask, and blending the target layer with the filtered normal data as the sonar echogram to form the polar output sonar image.

23. The method of claim 1, wherein the step of blending the target layer with the sonar echogram to form the polar output sonar image comprises the steps of:
dilating the target layer to form a dilated mask that encloses a spatial margin around the enhanced target;
masking the sonar echogram with the dilated mask to form a masked sonar echogram;
performing at least one of the steps of
low pass filtering the masked sonar echogram to obtain filtered normal data in which the step of low pass filtering have a lesser effect on data in the mask than areas not in the mask,
exponential moving average filtering the masked sonar echogram such that each element of the masked echogram is alpha_bypass*current_value+(1−alpha_bypass)*old_value, when the element is in the mask, or is alpha*current_value+(1−alpha)*old_value, otherwise, wherein 1≥alpha_bypass>alpha>0,
spatial low pass filtering the masked sonar echogram using at least one of a box or gaussian blur, convolving a first kernel chosen for the box or gaussian blur, K, across the masked sonar echogram on all points except the points in the mask, convolving a second kernel chosen for the box or gaussian blur, K_target, across the masked sonar echogram on all points in the mask; and
blending the target layer with the filtered normal data as the sonar echogram to form the polar output sonar image.

24. A method of accentuating at least one target ensonified in a fishing environment by a sonar system, without accentuating structures in the fishing environment also ensonified by the sonar system, for presentation on a fish finder display, comprising the steps of:
constructing a sonar echogram from sonar echo returns from the fishing environment ensonified by the sonar system;
convolving a predetermined template matrix on specific regions of the sonar echogram to form a target layer having an enhanced target contained therein;
blending the target layer with the sonar echogram to form an enhanced target sonar image; and
displaying the enhanced target sonar image on the fish finder display.
